(19) United States
(12) Patent Application Publication
(10) Pub. No.: US 2007/0295584 A1
(43) Pub. Date: Dec. 27, 2007

(54) CONTROL-SWITCH

(75) Inventors: Simone Koo, Palatine, IL (US); John C. Neumann, Chicago, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA INC, LIBERTYVILLE, IL (US)

(21) Appl. No.: 11/425,920

(22) Filed: Jun. 22, 2006

(51) Int. Cl. H01H 27/00

(52) U.S. Cl. 200/43.04

(57) ABSTRACT

Various embodiments of the present invention describe a control-switch (100) for an electronic device. This control-switch includes a pivot (102), a receptacle (104), a wire (106), and one or more switches such as (108) and (110). The wire couples data to the receptacle. The receptacle can receive a removable-switch interface. Further, the receptacle can move from a first position to a second position about the pivot. At the second position, one or more switches can be activated by the receptacle. Furthermore, a control circuit in the electronic device is activated at the second position by the one or more switches to modify an aspect of the data.

### FIELD OF THE INVENTION

This invention relates generally to switches. More particularly, the invention relates to a control-switch for controlling one or more aspects of data in an electronic device.

### BACKGROUND OF THE INVENTION

A switch is a device that is generally used to make and break a connection in an electrical circuit. In some switch applications, making and breaking an electrical circuit can control an aspect of data in an electronic device. Examples of electronic devices include amplitude modulation (AM) radios, frequency modulation (FM) radios, MP3 players, media centers, mobile phones, personal digital assistants (PDAs), computers, laptops, and the like. Data may be audio data, video data, audio-visual data, and the like. Examples of aspects of data include, but are not limited to, audio-volume, audio-bass, audio-treble, color-intensity, contrast-intensity, and brightness-intensity. An example of a switch used to control an aspect of data is an audio volume controller, which uses a switch to control the audio-volume of an electronic device such as an FM radio.

A switch can either be operated mechanically or through software-controlled electrical signals. Examples of a mechanically operated switch include a toggle switch, a rocker switch, a lever switch, a dimmer switch, and so forth. These mechanically operated switches can be actuated by transferring a user-applied force through a switch interface to switch circuitry. Examples of the switch interface include, but are not limited to, a toggle, a rocker, a lever, and a dial. The switch interface has a definite shape and size, and is often an additional component of the switch mechanism. This switch interface increases visual and cognitive complexities related to usability of the switch. Further, the switch interface requires a large surface area on the electronic device, which is a constraint in designing the electronic device.

### BRIEF DESCRIPTION OF DRAWINGS

Various embodiments will hereinafter be described in conjunction with the appended drawings provided to illustrate and not to limit the invention, wherein like designations denote like elements, and in which:

FIG. 1 is a view of a control-switch, in accordance with an embodiment.

FIG. 2 is a view of a removable-handle, in accordance with an embodiment.

FIG. 3 is a view of the control-switch with the removable-handle plugged in a receptacle, in accordance with an embodiment.

FIG. 4 is a view of the control-switch at a first position of the receptacle, in accordance with an embodiment.

FIG. 5 is a view of the control-switch in a forward-inclined second position of the receptacle, in accordance with an embodiment.

FIG. 6 is a view of the control-switch in a backward-inclined second position of the receptacle, in accordance with an embodiment.

FIG. 7 is a view of a control-switch with a finger-bump, in accordance with an embodiment.

FIG. 8 is a view of a control-switch having rotary encoders, in accordance with an embodiment.

FIG. 9 is a block diagram of an electronic device, in accordance with an embodiment.

FIG. 10 is a flowchart of a method for controlling at least one aspect of data in an electronic device, in accordance with an embodiment.

### DETAILED DESCRIPTION

Various embodiments of the present invention describe a control-switch for an electronic device. This control-switch includes a pivot, a receptacle, a wire, and at least one switch. The wire couples data to the receptacle. The receptacle can receive a removable-switch interface. Further, the receptacle moves from a first position to a second position about the pivot. At the second position, at least one switch is activated by the receptacle. Further, a control circuit in the electronic device is activated at the second position by the at least one switch to modify an aspect of the data going to the receptacle.

Various embodiments of the present invention also describe an electronic device. The electronic device includes a control-switch, along with other components such as a transceiver, a user interface, a display, a speaker, a memory, and a controller. The control switch includes a plug-receptacle and one or more spring-loaded buttons. The plug-receptacle is capable of moving from a first position to a second position about a pivot. The plug-receptacle further can provide data to an accessory-plug. At the second position, the one or more spring-loaded buttons are pressed by the plug-receptacle to actuate a control circuit in the electronic device for controlling one or more aspects of the data.

Various embodiments of the present invention further describe a method for controlling one or more aspects of data. The method includes moving a removable-switch interface attached to a switch-interface receptacle. The removable-switch interface can move the switch-interface receptacle from a first position to a second position. The switch-interface receptacle can provide data to the removable-switch interface. The method further includes activating at least one switch by the switch-interface receptacle at the second position. The method further includes actuating circuitry for controlling one or more aspects of the data when the at least one switch is activated.

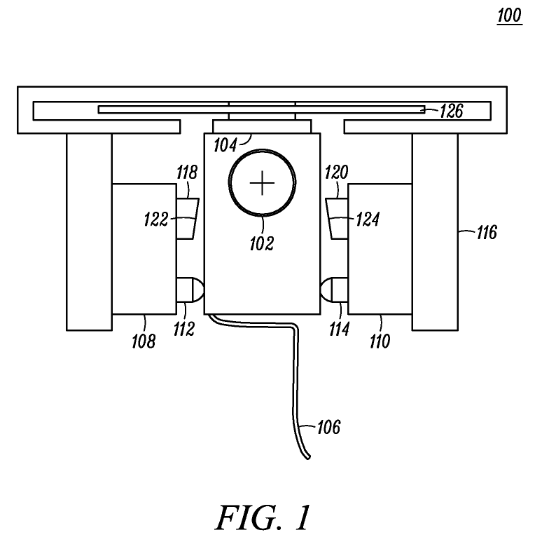

FIG. 1 is a view of a control-switch 100, in accordance with an embodiment. The control switch 100 includes a pivot 102, a receptacle 104, a wire 106 and one or more switches. In this embodiment, the control switch 100 includes two switches 108 and 110 which are used to control an aspect of data coupled through the wire 106. The one or more switches can include one or more push-buttons. In an embodiment, the switch 108 has a push-button 112 and the switch 110 has a push-button 114. It is possible to design the control switch 100 to include only one switch as well as three or more switches. Further, the control-switch 100 also includes a housing 116, and one or more stoppers such as a stopper 118 and a stopper 120. The housing 116 supports the pivot 102. The pivot 102 may be an axle. The receptacle 104 moves about the pivot 102 from a first position to a second position. It will be apparent to a person ordinarily skilled in the art that the second position of the receptacle 104 can be more than one position.

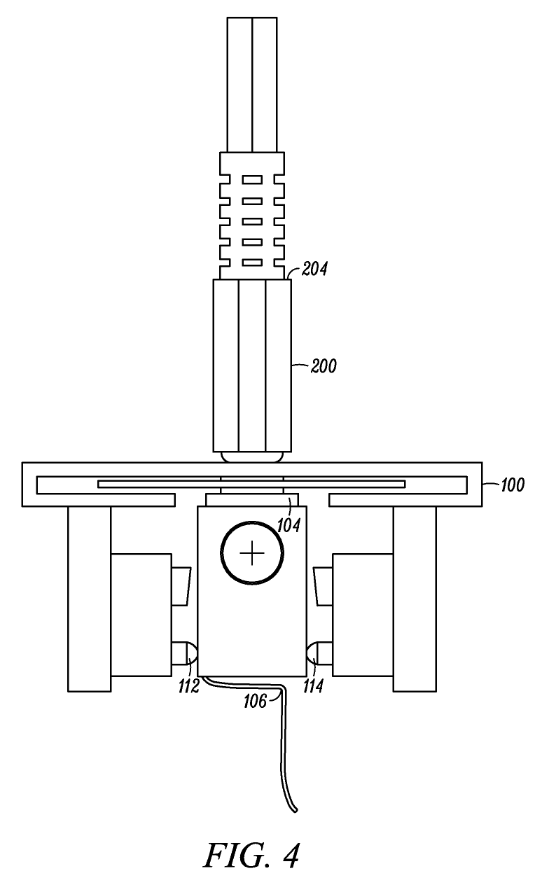

The first position and the second position are described in detail in conjunction with FIGS. 4-6. At a second position, the receptacle 104 press one or more push-buttons which activates the corresponding switch. For example, the switch 108 is activated when the push-button 112 is pressed by the receptacle 104. The switches 108 and 110 are coupled to a control circuit (not shown in FIG. 1). Further, the control circuit interprets signals from the switches 108 and 110 to control an aspect of the data sent to the receptacle 104 through the wire 106. The wire 106 can be a flexible wire. Further, the movement of the receptacle 104 at the second position can be restricted by the stoppers 118 and 120. Although the stoppers 118 and 120 are optional, in accordance with an embodiment, the stoppers 118 and 120 restrict the movement of the receptacle 104 at the second position to prevent damage to the push-buttons 112 and 114 from excessive pressure from pivoting the receptacle 104. In accordance with an embodiment, the stoppers have angled surfaces 122 and 124 which provide a maximum angle that the receptacle 104 can be moved, to actuate the push-buttons 112 and 114 without damaging to the push buttons 112 and 114 or the switches 108 and 110. An optional top-cover 126 slides to cover the receptacle 104, to limit dust and other debris from entering the receptacle 104 while allowing the intentional insertion of a removable-handle.

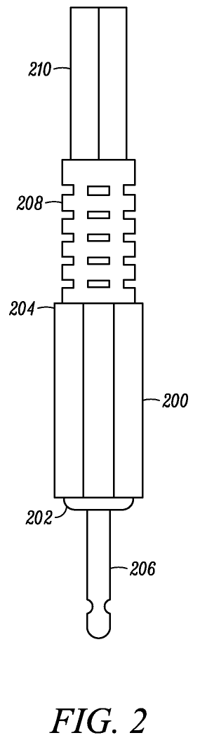

FIG. 2 is a view of a removable-handle 200, in accordance with an embodiment. The removable-handle 200 has a first-end 202 and a second-end 204. The first-end 202 is attached to a plug 206, which can be coupled to the receptacle 104 (shown in FIG. 1) to receive the data from the wire 106 (shown in FIG. 1). In accordance with an embodiment, the second-end 204 serves as a hand grip. In accordance with another embodiment, the second-end 204 connects to a headphone set through a strain relief 208 and a flexible cord 210. In accordance with an embodiment, the removable-handle 200 is a joystick-type handle connected to the receptacle 104 through the plug 206. A user can use the removable-handle 200 to move the receptacle 104 from a first position to a second position. The movement of the receptacle 104 from the first position to the second position controls one or more aspects of data moving through the receptacle 104 to the plug 206.

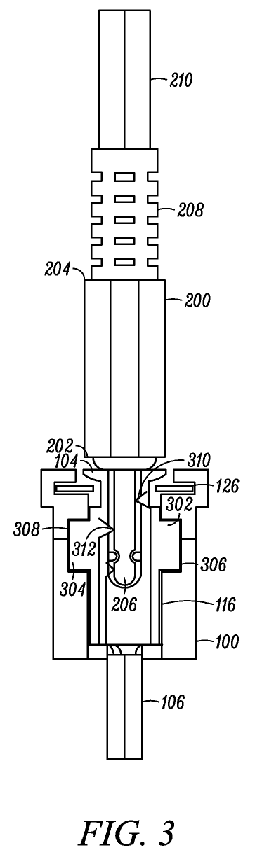

FIG. 3 is a view of the control-switch 100 with the removable-handle 200 plugged in the receptacle 104, in accordance with an embodiment. The orientation of the control-switch 100 as shown in FIG. 3 is rotated ninety degrees from the orientation of the control-switch 100 as shown in FIG. 1. The first end 202 of the removable-handle 200 rests on the top-cover 126 of the housing 116. The pivot 102 (shown in FIG. 1) is implemented using two cylindrical protrusions 302 and 304 on the outer surface of the receptacle 104. In an embodiment, the cylindrical protrusions 302 and 304 interact with cylindrical voids 306 and 308 on the inner surface of the housing 116 which allow the receptacle 104 to move from the first position to the second position. The wire 106 couples the data to the receptacle 104. Examples of data include, but are not limited to audio data, video data, and audio-visual data.

Electrical data connections from the wire 106 through the receptacle 104 to the plug 206 depend on the number of data lines and the nature of the data. For example, the removable handle 200, designed to be coupled to a stereo headset, can carry left audio signal and right audio signal data in the wire 106. The wire 106 can be coupled to the receptacle 104 through a first receptacle contact 310 for the left audio signal, and a second receptacle contact 312 for the right audio signal.

FIG. 4 is a view of the control-switch 100 at a first position of the receptacle 104, in accordance with an embodiment. In accordance with an embodiment, the control-switch 100 is non-functional at the first position. The push buttons 112 and 114 can apply force in opposite directions to maintain the receptacle 104 at the first position. An additional or alternate elastic mechanism, such as one or more springs, could be used to maintain the receptacle 104 at a neutral first position. The control circuit is not actuated to control an aspect of the data at the first position.

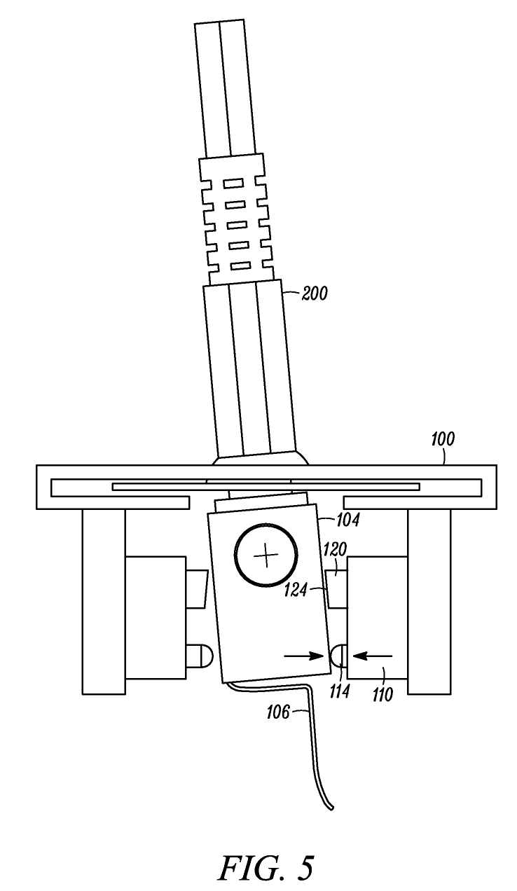

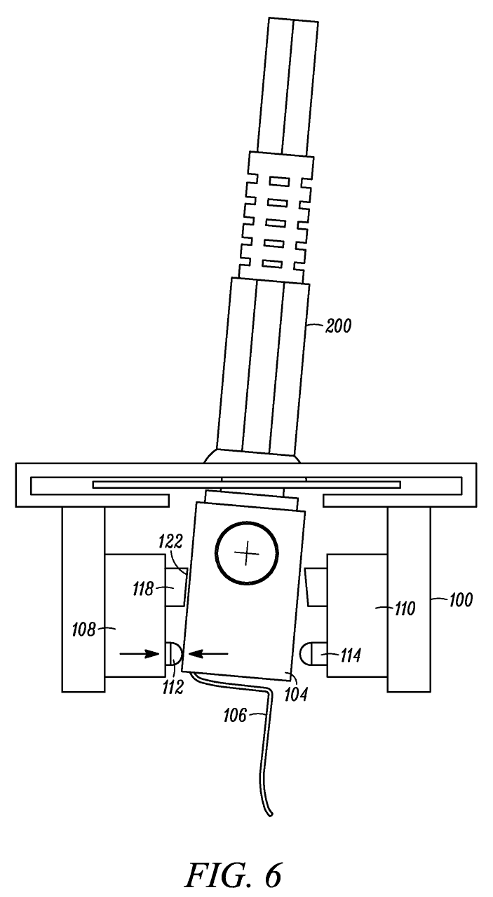

To actuate the control circuit, a user moves the removable-handle 200 to move the receptacle 104 from the first position to a second position. In accordance with an embodiment, the second position encompasses two positions, i.e., a forward-inclined second position (described in detail in conjunction with FIG. 5) and a backward-inclined second position (described in detail in conjunction with FIG. 6). Additional or alternate second positions can also be implemented, such as a left-inclined second position and a right-inclined second position. The wire 106 is designed to accommodate the first position and all acceptable second positions.

FIG. 5 is a view of the control-switch 100 in the forward-inclined second position of the receptacle 104, in accordance with an embodiment. It will be apparent to a person ordinarily skilled in the art that the second position of the receptacle 104 can be more than one position. In accordance with an embodiment, the control-switch 100 can be operated in two directions, e.g., in a forward direction and in a backward direction. The view depicts the receptacle 104, inclined in the forward direction, pressing the push button 114, which includes one or more springs.

Depression of the push button 114 activates the switch 110 to control one or more aspects of data carried by the wire 106. Upon depression of the push button 114, the one or more springs provide a force to urge the receptacle 104 to move back to the first position. The stopper 120 restricts the movement of the receptacle 104 at the limit of the forward-inclined second position. In this embodiment, the stopper 120 has an inclined surface 124 to better contact with the receptacle 104, and to provide a maximum angle to which the receptacle 104 can incline.

Further, pressing the push-button 114 may increase the audio volume of audio data received or generated by an electronic device. Depending on the control circuit interpreting the switch 110 output, a single depression of the push button 114 may increase the audio volume in one step, and further separate activations of the push button 114 are needed to further increase the audio volume by steps. Or alternately, a “push and hold” of the push button 114 may cause the audio volume to increase until the push button 114 is released. In another example, pressing the push-button 114 actuates the control circuit to switch-on an audio player or an audiovisual player.

FIG. 6 is a view of the control-switch 100 in the backward-inclined second position of the receptacle 104, in accordance with an embodiment. In accordance with an embodiment, the backward-inclined second position is the reverse of the forward-inclined second position (as described in FIG. 5) of the receptacle 104. As shown in FIG. 6, the push-button 112 is pressed by the receptacle 104 in a direction that is opposite to the direction in which the push-button 114 is pushed. The stopper 118 restricts the movement of the receptacle 104 at the limit of the backward-inclined second position. At the second position, the push-button 112 actuates a switch 108 which is coupled to the control circuit in the electronic device. For example, pressing the push-button 112 may decrease the audio volume of audio data carried by the wire 106. In another example, pressing the push-button 112 actuates the control circuit to switch-off an audio player or an audiovisual player.

The control-switch 100 can be put into a hold state so that the control-switch 100 does not actuate the control circuit in the electronic device. In accordance with an embodiment, a hold-button is pressed to remove the connection between the control-switch 100 and the control circuit. The hold state prevents unintentional movement of the removable handle 200 or receptacle 104 from making unwelcome changes to the data carried by the wire 106. Examples of the hold-button include, but are not limited to, a surface mount switch, a press-button, and a slide switch. An additional or alternate method for placing the control-switch 100 into a hold state is through a software function implemented through a menu interface of the electronic device that causes the control circuit to disregard any signals from the switches 108 and 110. A further additional or alternate method for implementing a hold state is a mechanical latch that locks the receptacle 104 into the neutral first position.

In FIGS. 4-6, the receptacle 104 has been described as having a neutral first position and two second positions. In accordance with an embodiment previously mentioned, the receptacle 104 is capable of moving in four directions. This four-way multi-directional switch can control multiple aspects of data. For example, a four-way multi-directional switch can control bass, treble, volume increase, and volume decrease of an audio data stream. Alternately, a four-way multi-directional switch could control volume increase, volume decrease, channel increment, and channel decrement of an audiovisual data stream for an electronic device such as a television.

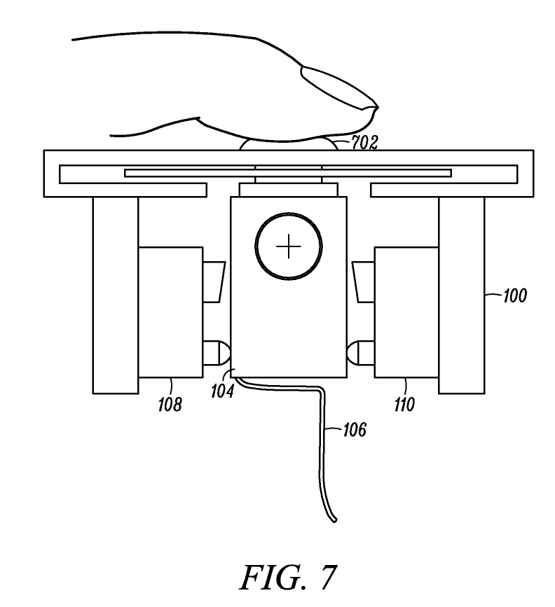

FIG. 7 is a view of a control-switch 100 with a finger-bump 702, in accordance with an embodiment. The finger-bump 702 can be attached to the receptacle 104, and serves a function similar to the removable handle 200 (shown in FIGS. 2-6). In accordance with an embodiment, the finger-bump 702 is coupled to the receptacle 104 and is used to move the receptacle 104 from a first position to a second position, when pressed by a user's fingertip. In accordance with an embodiment, the receptacle 104 can be moved in one or more directions by using the finger-bump 702. The finger-bump 702 can be made of plastic and can be of various shapes, such as a hemispherical shape, a cylindrical shape, a cuboid shape, a convex shape, and the like.

In an embodiment, the finger-bump 702 has a hole that accepts a plug 206 of a removable handle 200, and thus a removable handle 200 can be used in conjunction with a finger-bump 702 to control one or more aspects of data on the wire 106. Thus, a switch interface can be implemented as a removable handle 200, or a finger-bump 702 that is used to move the receptacle 104, or other type of receptacle to actuate at least one switch 108 and 110 to control at least one aspect of data through wire 106. In another embodiment, the finger-bump 702 is non-separable part integrated with the receptacle 104. The receptacle 104, in addition to actuating the control-switch 100, also receives the data and can couple it to the removable handle 200.

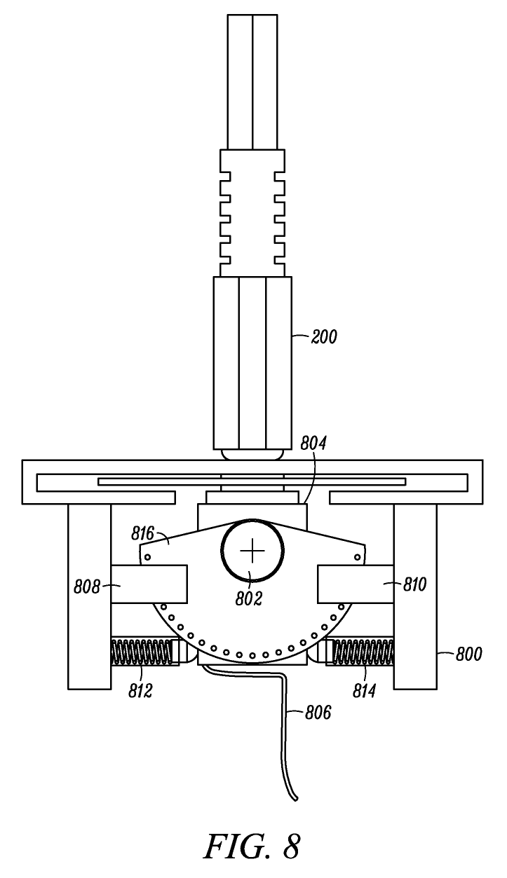

FIG. 8 is a view of a control-switch 800 having rotary encoders, in accordance with an embodiment. The control-switch 800 can track angular movement of a receptacle, and the control-switch 800 activates a control circuit, based on the angular movement. The control circuit further controls one or more aspects of data coupled to the receptacle by a wire 806. The control switch 800 includes a receptacle 804, a pivot 802, a wire 806, at least one rotary encoder, such as encoder 808 and encoder 810, and one or more springs, such as spring 812 and spring 814. The receptacle 804 can rotate about the pivot 802. The receptacle 804 further includes a removable-switch interface on which the removable-handle 200 can be attached. Data passes to the removable handle 200 when it is coupled to the control-switch 800. The wire 806 couples the outgoing data to the receptacle 804. The receptacle 804 can be moved from a first position to a second position by the removable-handle 200 about the pivot 802. In an embodiment, the removable handle 200 can be attached to an accessory, for example a headset.

In an embodiment, a first position of the receptacle 804 does not control one or more aspects of the data, and a second position of the receptacle 804 controls one or more aspects of the data. FIG. 8 shows the first position of the control switch 800. The second positions of the control-switch 800 are a forward-inclined position and a backward-inclined position. A user can move the receptacle 804 to the second position from the first position by pushing the removable handle 200. The one or more springs 812, 814 apply force to the receptacle 804 to regain the first position.

At the second positions, at least one of the encoder 808 and encoder 810 tracks the angular movement of a code disk 816 coupled with the receptacle 804. The code disk 816 can generate rotational signals. The one or more optical decoders decode angle of rotation of the receptacle 804, based on the rotational signals. Further, at least one aspect of the data can be controlled based on the angle of rotation. In an embodiment, volume of audio data is increased based on the angular movement of the receptacle 804 in a given direction. For example, at a 30 degree angle in a clockwise direction, volume of audio data increases at a lower rate compared to at a 45 degree angle. Similarly, at a 30 degree angle in a counter clockwise direction, volume of audio data decreases at a lower rate compared to at a −45 degree angle.

In accordance with an alternate embodiment similar to the rotary encoder embodiment, the one or more switches in the control switch 100 are one or more brush switches. A jog dial (not shown in FIG. 8) can be coupled with the receptacle 104 which rotates the receptacle 104 about a vertical pivot. The receptacle 104 rotates from a first position to a second position brushing the one or more brush switches. The one or more brush switches may include one or more rollers which rotate when an external surface brushes on the one or more rollers. In an embodiment, the cylindrical surface of the receptacle 104 brush on the one or more rollers. The one or more brush switches are also capable of tracking rotation of the rollers. A control circuit in an electronic device is actuated, based on the rotation. Further, the control circuit controls at least one aspect of data based on the rotation.

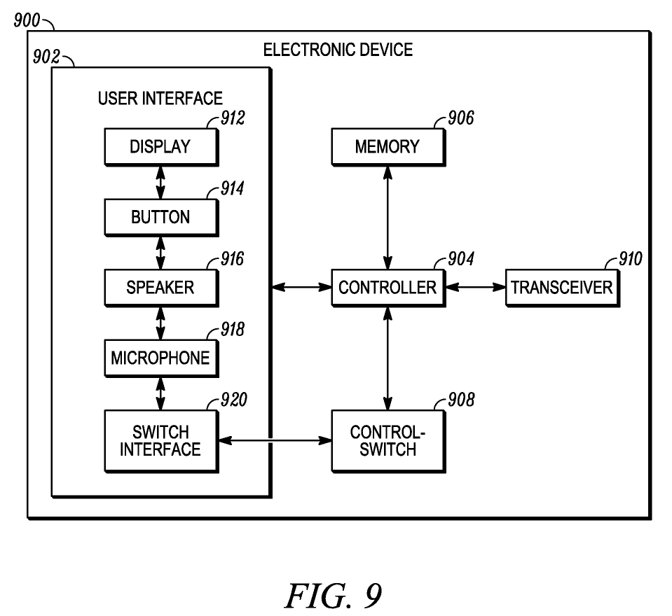

FIG. 9 is a block diagram of an electronic device 900, in accordance with an embodiment. The block diagram depicts the operational relationship between various components in the electronic device 900. In this embodiment, the electronic device 900 is a mobile communication device, sometimes referred as a cellular telephone or user equipment. The electronic device 900 can alternately be an amplitude modulation (AM) radio, a frequency modulation (FM) radio, an MP3 player, a personal digital assistant (PDA), a computer, a Digital Versatile Disk (DVD) player, a television set, or the like. The electronic device 900 includes a user interface 902, a controller 904, a memory 906, a control-switch 908 and a transceiver 910. The user interface 902 is operatively coupled with the controller 904. Input is provided by a user to the electronic device 900 by the user interface 902. Data provided by the user can be stored in the memory 906 coupled with the controller 904. The memory 906 can be a database. The controller 904 can also transmit and receive data using the transceiver 910.

The user interface 902 includes a display 912, one or more buttons such as a button 914, one or more speakers such as a speaker 916, a microphone 918, and a switch interface 920. A user can use the one or more buttons to select a menu for operating the electronic device 900. For example, a user can select a voice-recorder option from the display 912 using the button 914, and record his voice by speaking to the microphone 918. This voice data is processed in the controller 904 and stored in the memory 906. In an embodiment, the switch interface 920 enables a removable handle 200 to be attached to the control-switch 908. The control switch 908 can be one of the control switch 100 and the control switch 800. In this embodiment, the control switch 908 is implemented as control switch 100. The removable handle 200 can move the receptacle 104 from a first position to a second position. At the second position, the one or more switches are activated, which in turn actuates a control circuit in the controller 904. The controller 904 further controls one or more aspects of the data going to the user interface through the switch interface 920. In accordance with an embodiment, the switch interface 920 is coupled to an external display accessory and the control-switch 100 controls the one or more aspects of a video data stream, such as its color-intensity, contrast-intensity, or its brightness-intensity. In accordance with another embodiment, the data is an audio data stream, the switch interface 920 is coupled to a headset, and the control-switch 100 controls one or more aspects of the audio data stream, such as its volume intensity.

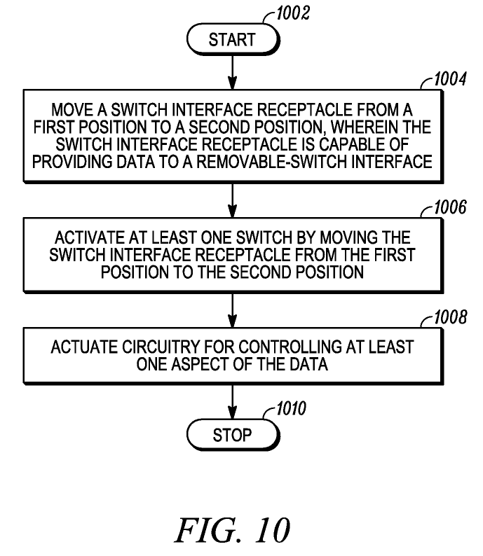

FIG. 10 is a flowchart of a method for controlling one or more aspect of data in an electronic device 900, in accordance with an embodiment. At step 1002, the method is initiated. In an optional step, a switch-interface receptacle in the electronic device 900 is coupled to with a removable-switch interface. Alternatively, a finger-bump or the like can be a part of the switch-interface receptacle. In another optional step, data is coupled to the switch-interface receptacle by a wire. In another optional step, the control switch 100 can be put in a hold state and released from a hold state by software or a mechanical mechanism. At step 1004, the removable-switch interface is moved by a user, and in turn the removable-switch interface moves the control-switch 100 receptacle from a first position to a second position.

At step 1006, at least one switch in an electronic device 900 is activated by moving the control-switch 100 receptacle to the second position. At step 1008, circuitry for controlling at least one aspect of the data is actuated. Examples of the data include, but are not limited to, an audio data stream, a video data stream, and an audio-video data stream. Examples of aspects of an audio data stream include, but are not limited to, volume, bass, treble, and so forth. Examples of aspects of a video data stream include, but are not limited to, color-intensity, contrast, brightness, and so forth. Further, examples of aspects of an audio-video data stream include, but are not limited to, color-intensity, audio-volume, color-contrast, audio-bass, and so forth. In an optional step, the control-switch receptacle is moved back to the first position from the second position by one or more springs in the control-switch 100. Thereafter, at step 1010, the method is terminated. Note that the optional steps can be re-ordered within the flowchart shown. For example, if the aspect of the data controlled by the control-switch 100 is an ON/OFF state, then the optional step of coupling data to the switch-interface receptacle would occur after step 1008.

Therefore, it should be clear from the preceding disclosure that the invention provides a control-switch, an electronic device, and a method for controlling one or more aspects of data coupled to the control-switch. The control-switch can be operated by using a removable-handle, which is convenient to carry and use with the electronic device. Further, the control-switch can control one or more aspects of data. Moreover, the control-switch can be used both as an on/off switch as well as a regulator.

The instant disclosure is provided to further explain, in an enabling manner, the best modes of making and using various embodiments, in accordance with the present invention. The disclosure intends to enhance the perception and appreciation of the inventive principles and advantages thereof, rather than to limit in any manner the invention. The invention is defined solely by the appended claims, including any amendments made during the pendency of this application, and all the equivalents of the claims, as issued.

It is further understood that the relational terms, if any, such as first and second, top and bottom, forward and backward, and the like, are used solely to distinguish one entity or action from another, without necessarily requiring or implying any actual relationship or order between such entities or actions.

This disclosure is intended to explain how to fashion and use various embodiments in accordance with the invention rather than to limit the true, intended, and fair scope and spirit thereof. The foregoing description is not intended to be exhaustive or to limit the invention to the precise forms disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

What is claimed is:

1. A control-switch for an electronic device, the control-switch comprising:
a pivot;
a receptacle capable of receiving a removable-switch interface and capable of moving from a first position to a second position about the pivot;
a wire for coupling data to the receptacle; and
at least one switch capable of being activated by the receptacle at the second position for actuating a control circuit in the electronic device to modify an aspect of the data when activated.

2. The control-switch as recited in claim 1 further comprising a housing for supporting the pivot.

3. The control-switch as recited in claim 2, wherein the pivot is an axle.

4. The control-switch as recited in claim 2, wherein the housing comprises at least one stopper for restricting movement of the receptacle.

5. The control-switch as recited in claim 1, wherein the wire is a flexible-wire.

6. The control-switch as recited in claim 1 further comprising one or more springs for urging the receptacle to the first position.

7. The control-switch as recited in claim 1, wherein the receptacle comprises a finger-bump capable of moving the receptacle from the first position to the second position when moved by a user's finger.

8. The control-switch as recited in claim 1, wherein the removable-switch interface comprises a plug attached to an accessory.

9. The control-switch as recited in claim 8, wherein the receptacle is capable of providing the data to the plug.

10. The control-switch as recited in claim 1, wherein the data is selected from a group comprising: audio data, video data, and audio-visual data.

11. The control-switch as recited in claim 1, wherein the data is audio data and at least one aspect of the audio data is selected from a group comprising: pitch, intensity, and volume.

12. The control-switch as recited in claim 1, wherein the data is video data and at least one aspect of the video data is selected from a group comprising: color intensity, brightness intensity, and contrast intensity.

13. The control-switch as recited in claim 1, wherein the receptacle comprises a code disk capable of generating rotational signals.

14. The control-switch as recited in claim 13, wherein the at least one switch comprises an optical decoder capable of decoding angle of rotation based on the rotational signals.

15. An electronic device comprising:
a control-switch for controlling at least one component of a signal of the electronic device, the control-switch comprising:
a plug-receptacle capable of moving from a first position to a second position, the plug-receptacle further capable of providing data to an accessory-plug; and
at least one switch capable of being activated by the plug-receptacle at the second position to actuate a control circuit in the electronic device.

16. The electronic device as recited in claim 15, wherein the accessory-plug is capable of being inserted into the plug-receptacle and assisting the moving of the plug-receptacle from the first position to the second position.

17. The electronic device as recited in claim 15, wherein the accessory-plug is attached to a headset.

18. The electronic device as recited in claim 15, wherein the accessory-plug is attached to a display

19. The electronic device as recited in claim 15, wherein the plug-receptacle comprises a surface capable of being moved by a user's fingertip.

20. The electronic device as recited in claim 15 further comprising a receiver for receiving the signal.

21. A method for controlling at least one aspect of data in an electronic device, the method comprising:
moving a switch interface receptacle from a first position to a second position, wherein the switch interface receptacle is capable of providing data to a removable-switch interface;
activating at least one switch by moving the switch interface receptacle from the first position to the second position; and
actuating a circuit for controlling the at least one aspect of the data upon activating the at least one switch.

22. The method as recited in claim 21 further comprising:
inactivating the circuit when a user actuates a hold-switch, wherein the hold-switch is operatively coupled to the circuit.
